(19) United States
(12) Patent Application Publication
(10) Pub. No.: US 2017/0277687 A1
(43) Pub. Date: Sep. 28, 2017

(54) SYSTEM AND METHODS FOR SEARCHING DOCUMENTS IN A RELATIONAL DATABASE USING A TREE STRUCTURE STORED IN A TABULAR FORMAT

(71) Applicant: Lexmark Internatioanl Technology, Sarl, Meyrin (CH)

(72) Inventor: Christopher Bradley Sammis, Shawnee, KS (US)

(21) Appl. No.: 15/147,890

(22) Filed: May 5, 2016

Related U.S. Application Data
(60) Provisional application No. 62/157,347, filed on May 5, 2015.

(51) Int. Cl. G06F 17/30

(52) U.S. Cl. CPC G06F 17/30011; G06F 17/30106; G06F 17/30327; G06F 17/30339; G06F 17/30112

(57) ABSTRACT

System and methods of searching documents in a relational database that includes receiving a search query from an application; identifying, via an ancestry table, node identifiers corresponding to the search query; determining, from the corresponding node identifiers, ancestor node identifiers having a depth value greater than zero; and displaying identifiers associated with the ancestor node identifiers to a user. Each entry in the ancestry table includes a node identifier, an ancestor node identifier associated with the node identifier and a depth value corresponding to a distance between the node identifier and the ancestor identifier.

### CROSS REFERENCES TO RELATED APPLICATIONS

The present application is related to and claims priority under 35 U.S.C. 119(e) from U.S. provisional application No. 62/157,347, filed May 5, 2015 entitled, “Method of Searching a Tree Structure,” the contents of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to processing a hierarchical model, and more specifically, processing a tree structure having one or more nodes.

2. Description of the Related Art

Hierarchical data structure models, such as a tree, have been widely used in computer science to store and organize data. Some of the most common uses of trees include representing hierarchical data, storing searchable data, routing algorithms, and representing sorted lists of data. There are many different applications of trees and consequently, there are many different algorithms available for manipulating tree structures. However, many of these existing algorithms perform a systematic visit to all the nodes in the tree, a process that is also called tree traversal.

Tree traversal refers to a process of examining and/or updating each of the nodes in a given tree. Traversal of a tree may be defined recursively such that most methods of traversing a tree involve a process of iteration or looping over the nodes in the tree. For trees not having a linear data structure, or trees having one or more nodes containing more than one possible next node, deferring some nodes during the tree traversal may be performed. For example, the deferred nodes may be implicitly stored and visited at a further step in the tree traversal process. While tree traversal is used in several operations, such as searching for and returning nodes having a certain property, the recursive nature of the process may make tree traversal slow and time-consuming, especially when the tree to be processed is large. Additionally, queries performed using tables stored in a relational database may be expensive to perform, and executing queries on tree structures, and as part of a recursive step, may represent prohibitive costs in computational time and memory usage.

Thus, there is a need for a more efficient method of processing a hierarchical model or a tree structure in a relational database in order to perform more efficient and fast queries on the tree without undergoing recursion or tree traversal every time a query is executed.

### SUMMARY

System and methods of searching are disclosed herein. A first example embodiment of searching documents in a relational database includes receiving a search query from an application; identifying, via an ancestry table, node identifiers corresponding to the search query; determining, from the corresponding node identifiers, ancestor node identifiers having a depth value greater than zero; and displaying identifiers associated with the ancestor node identifiers to a user. Each entry in the ancestry table includes a node identifier, an ancestor node identifier associated with the node identifier and a depth value corresponding to a distance between the node identifier and the ancestor identifier.

A second example embodiment of searching a tree structure having one or more nodes includes receiving a search query; identifying, via an ancestry table, nodes matching the search query; returning the matching nodes; and using the matching nodes to identify corresponding container nodes. In an aspect of this example embodiment, the tree structure may correspond to a file system, and the one or more nodes of the tree structure may correspond to documents and/or folders in the file system.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 illustrates one example tree, tree structure or hierarchical model.

FIG. 2 is one example method of processing a tree structure or hierarchical model and creating or generating a corresponding hierarchical or ancestry table.

FIGS. 3A-3C illustrate the example tree structure of FIG. 1 and its corresponding table at various stages of generation using the example method of FIG. 2.

FIG. 3D illustrates a hierarchical table for the example tree of FIG. 1 after the processing of the example tree has been completed.

FIG. 4 is an example node table corresponding to the example tree structure of FIG. 1.

FIG. 5 shows one shows one example method 500 for searching a relational database using the example hierarchical table of FIG. 3D.

FIG. 6 shows an example temporary table formed during the execution of the example method in FIG. 5.

FIG. 7 shows one shows one example method 500 for searching a relational database using the example hierarchical table of FIG. 3D.

FIG. 8 shows a third example method for searching a relational database using the hierarchical table of FIG. 3D.

### DETAILED DESCRIPTION

It is to be understood that this disclosure is not limited to the details of construction and the arrangement of components set forth in the following description or illustrated in the drawings. This disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of this disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof, as well as additional items. Further, the terms “a” and “an” herein do not denote a limitation of quantity, but rather denote the presence of at least one of the referenced item.

In addition, it should be understood that example embodiments of this disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks. Output of the computer program instructions, such as tables corresponding to tree structures, as will be described in greater detail below, may be displayed in a user interface or computer display of the computer or programmable apparatus that implements the functions or the computer program instructions.

Disclosed are methods of processing a tree structure having one or more nodes. The method may include identifying container nodes of the tree structure and generating a depth value for each pair of the container nodes identified, wherein the depth value corresponds to a distance between the container nodes identified in the tree structure.

As used herein, a tree structure may refer to a data structure that stores and organizes data by simulating a hierarchical tree structure with a set of one or more linked nodes. The tree structure may be a collection of one or more nodes, wherein each node may consist of a value.

For illustrative purposes, the example tree structures discussed in this disclosure are represented as growing downwards. The tree structure may include at least one node, which may include a value and/or a condition.

Each of the nodes in the tree structure may have no child nodes or contain one or more child nodes. Child nodes are nodes that are connected below a particular node in the tree structure. A node in the tree structure having a child may be referred to as the child's parent node. A node that has no or zero child nodes is a leaf node. A leaf node may also be referred to as an outer node, an external node, or a terminal node.

A container node refers to any node of the tree structure that contains at least one child node. The container node may also be referred to as an inner node, an internal node or a branch node.

The tree structure has a topmost node that may be referred herein as a root node. The root node, being the node at the top of the tree structure, does not have a parent node. For illustrative purposes, the root node may be represented as the node drawn at the top of the tree.

In one example embodiment, the tree structure may refer to a file system, and the one or more nodes of the tree structure may refer to documents and/or folders in the file system organized hierarchically. Nodes that refer to documents may be represented by leaf nodes while nodes that refer to folders may be represented in the tree structure as container nodes.

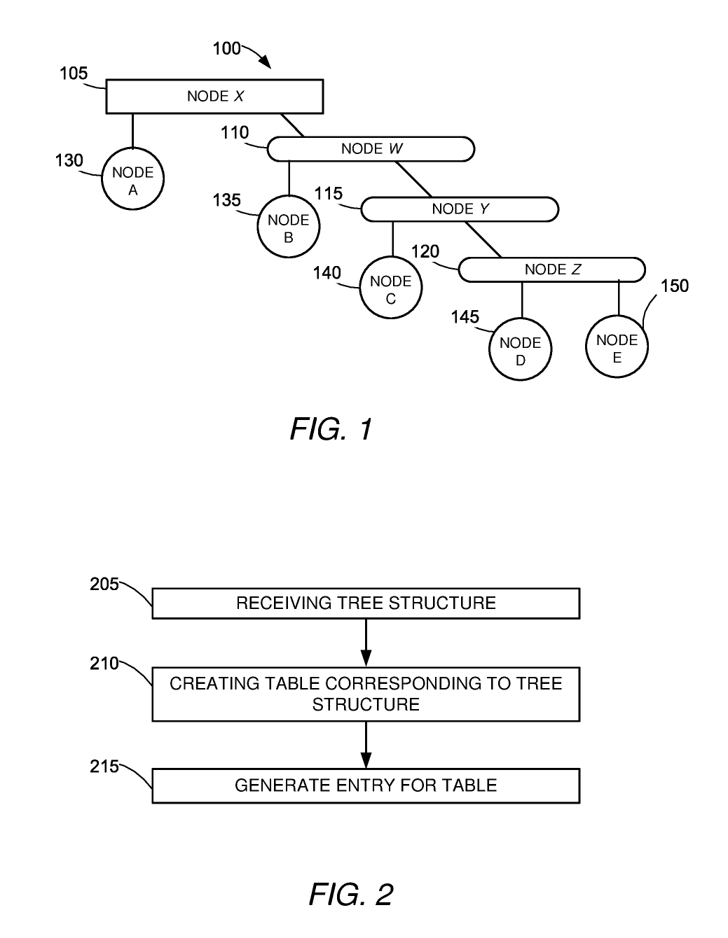

FIG. 1 illustrates one example tree, tree structure or hierarchical model 100. Example tree 100 has four container nodes 105, 110, 115, and 120, labeled Node X, Node W, Node Y, and Node Z, respectively. Example tree 100 also has one leaf node 125, labeled as Node A.

FIG. 2 is one example method of processing a tree structure or hierarchical model and creating or generating a corresponding hierarchical or ancestry table.

At block 205, a tree structure to be processed may be received. Receiving a tree structure may include receiving a hierarchical model from a user of the computing device. In some alternative example embodiments, receiving a tree may include identifying a hierarchical model stored in the memory of the computing device for processing.

Processing a tree structure or hierarchical model may include generating an ancestry or hierarchical table corresponding to the tree structure, as will be described in greater detail below.

At block 210, an ancestry or hierarchical table corresponding to the tree structure may be created. The hierarchical table is a table which lists container nodes corresponding to the tree structure. The hierarchical may include multiple columns such as a Node_ID column, and Ancestor_ID column, and a Depth column.

The Node_ID column may include identifiers or values corresponding to container nodes from the tree structure. The ancestor identifier may correspond to the node represented by the node identifier generated. The Ancestor_ID column may include identifiers or values corresponding to one or more immediate or non-immediate parent nodes of the node in the Node_ID column. For every row entry in the hierarchical table, an ancestor identifier may be paired or associated with a container node identifier, and this pair may be referred to as a node-ancestor pair. All nodes in the tree structure received at block 205 may be generated with at least one entry in the table.

The Depth column contains values indicating the depth or distance between the container node and parent node of the same row (i.e., the node-ancestor pair). For example, for identity relationship records wherein the ancestor identifier paired with the node identifier is the node identifier itself, the depth value of the node-ancestor pair may be “0”. This indicates that the container node referred to by the ancestor identifier and the node identifier is the same node, thus the two identifiers having “0” depth or distance from each other. In another example, if the ancestor identifier paired with the node identifier is the immediate parent of the node, the depth value of the pair may be “1”.

The use of identifiers corresponding to the container nodes and nodes a table for illustrative purposes and should not be considered limiting. The example embodiments detailed in the present disclosure may also be performed without the use of identifiers, as is known in the art.

An entry in the hierarchical table having a node identifier and an ancestor identifier that refer to the same node may be referred to herein as an identity relationship entry of the node. In alternative example embodiments, the ancestor identifier may refer to a parent node of the node identifier. In other alternative example embodiments, the ancestor identifier may refer to the parent of the parent node. In yet other alternative example embodiments, each node identifier may be generated with an entry in the table with a corresponding ancestor identifier (i.e., a node-ancestor pair) until the ancestor identifier paired with the node identifier is the root node, as will be described in greater detail below.

In some example embodiments, additional columns indicating one or more properties of a node may be included in the table. For example, additional columns may include a user-definable name for the node, a timestamp indicating the time at which the node was added to the tree structure, and/or a status indicating whether the node is locked for modification by an entity in a multi-user system. Other properties may be apparent to one of ordinary skill in the art.

At block 215, an entry in the hierarchical table may be generated. The entry or row in the table includes a node-identifier pair, which consists of node identifier and ancestor identifier, and a depth value for each node-ancestor pair. The entry in the table may be added by the user of the computing device, or may be added automatically through one or more methods that will be apparent.

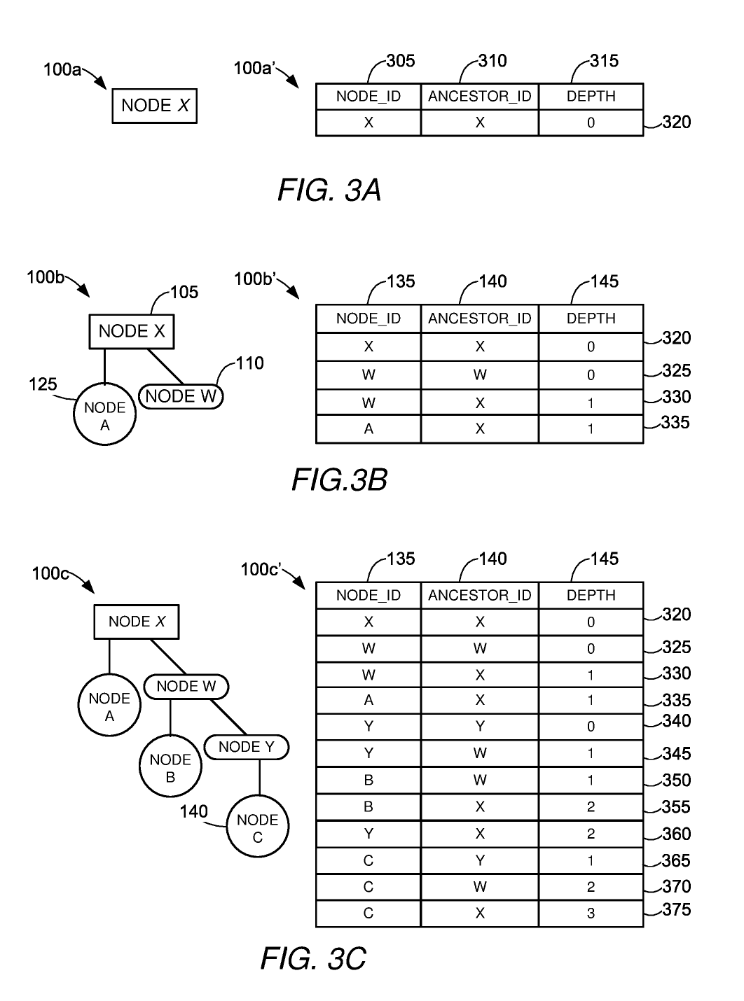

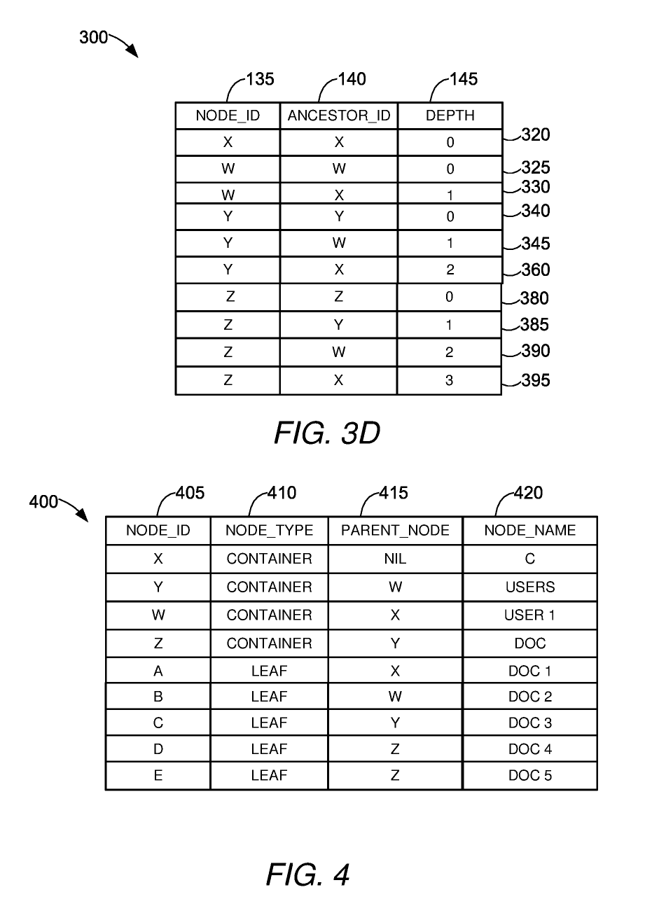

FIGS. 3A-3C illustrate example tree structure 100 of FIG. 1 and its corresponding table at various stages of generation using the example method of FIG. 2. FIG. 3D illustrates a hierarchical table 300 for example tree 100 after the processing of tree 100 has been completed.

Example tree portion 100a, 100b, and 100c have one or more nodes, with corresponding tables 100a′, 100b′, and 100c ′, respectively. Example tree portions 100a, 100b, and 100c and corresponding hierarchical tables 100a′, 100b′, and 100c ′, respectively are described herein for illustrative purposes and should not be considered limiting.

Each of tree portions 100a, 100b, and 100c represent example tree 100 that is built over time, with tree portion 100a being the starting point of the tree generation and tree 100 being the end point in example tree 100 generation. Similarly, hierarchical tables 100a′, 100b′ and 100c′ show the building of hierarchical table 300 corresponding to example tree structure 100, in conjunction with method 100 of FIG. 2.

Hierarchical tables 100a′, 100b′, and 100c′ may contain columns NODE_ID 135, ANCESTOR_ID 140 and DEPTH 145. NODE_ID 135 may identify nodes, ANCESTOR_ID 140 may contain ancestor identifiers paired with the node identifiers in NODE_ID 135, and DEPTH 145 may contain depth values between the node identifier and ancestor identifier values indicated in NODE_ID 305 and ANCESTOR ID 310 (i.e., the node-ancestor pair), respectively.

Tree portion 100a contains one node—Node X. Node X may be the topmost node in tree 100a and subsequent trees 100b and 100c, and may be referred to as the root node. As will be known in the art, node X, being the topmost node, does not have a parent node.

Table 100a′ in FIG. 3A may contain one entry 320 corresponding to node X in tree 300a. In entry 320, NODE_ID 305 contains X which may refer to an example unique identifier for node X in tree 300a. ANCESTOR ID 310 may contain X which may refer to the unique identifier for node X in tree 300a. Depth value in DEPTH 315 for the node-ancestor pair in entry 320 is “0,” which may indicate that the node identifier and the ancestor identifier in entry 320 may correspond to the same node in tree 300a. Entry 320 may be an example identity relationship entry—an entry having depth value “0”, and may indicate a node's relationship with and distance from itself.

As seen in FIG. 3B, in tree 100b, container node W 110 and leaf node A 125 may be added as descendants of node X 105. With the addition of node W 125, two records may be added in table 100b′ in order to correspond to the updated tree 100b. In table 100b′, entries 325 and 330 may be added to the table—an identity relationship for node W (entry 325) and a relationship entry between node W and node X (entry 330). The depth value in entry 330 is “1”, which may correspond to the distance between nodes W and Y. With the addition of node A, one record 335 may be added in table 300b′ in order to correspond to the updated tree 100b.

An entry in the table corresponding to a tree may be generated for every node and all of its parent nodes until the root node. For example, in tree 100c, container node Y 115 and leave nodes B and C may be added to the tree, and eight records may be added to table 100c ′ to correspond to the updated tree 100c. Table 300c′ may contain new entries 340-375. Entry 340 may be the identity relationship entry for node Y, having depth value “0.” Entry 345 may correspond to the relationship between node W and node Y, the immediate parent node of node Y. The relationship entry 345 having depth value “1”, corresponding to the distance between nodes W and Y. Entry 355 may correspond to the relationship between node B and node X, the root node. The relationship between nodes B and X may be indicated as having depth value “2”, which corresponds the distance between nodes B and X.

Leaf nodes may not be generated with an entry in the table. For example, in tree 100a, a node A may be added to the tree. Since new node A is a leaf node—or a node having no child in the tree—node A may not be generated with a corresponding entry in the table. Thus, it may be appreciated that a table generated to correspond to a tree structure may represent one or more non-leaf nodes in the table. In alternative example embodiments, leaf nodes may be generated with corresponding entries in the table, along with ancestor identifiers and depth values of the ancestor for its one or more parent nodes.

Example tree 100a and corresponding table 100a′ may be used to illustrate one or more example applications that may be performed using the example embodiments described herein.

FIG. 3D illustrates a hierarchical table 300 for example tree 100 without leaf node entries after the processing of tree 100 has been completed. Hierarchical table 300 may include columns labeled NODE_ID 135, ANCESTOR_ID 140, and DEPTH 145 and row entries 320-395. Row entries 320-395 in hierarchical table 300 show permutations of the relationships and corresponding depths (or distance values) between container nodes. For example, the depth or distance value of Node X from Node Z of tree 300 is 3, as reflected in row entry 395.

FIG. 4 is an example node table 400 corresponding to the tree 100 of FIG. 1. Node table 400 may represent relationships between leaf nodes and container nodes as well as the immediate parent node of each unique node. Node table 400 may include columns with labels such as, but not limited to, NODE_ID 405, NODE TYPE 410, PARENT NODE 415 and NODE_NAME 415. NODE_NAME 420 may be the identifier, such as a directory or file name associated with corresponding NODE_ID 420. For example, node X may correspond to a directory named “C”, and node A may be a file named “DOC1”.

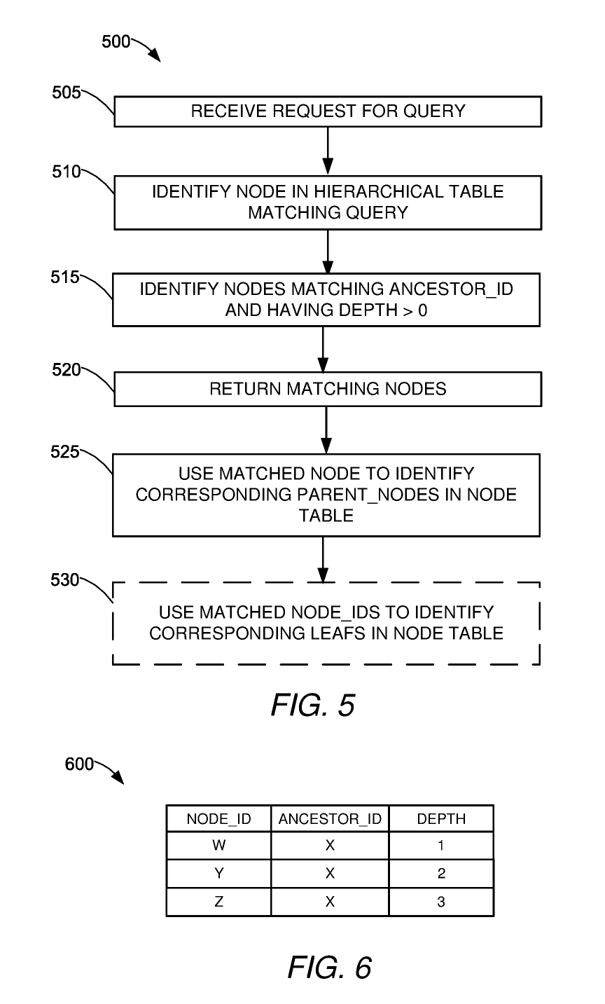

FIG. 5 shows one shows one example method 500 for searching a relational database using the example hierarchical table of FIG. 3D.

At block 505, an example application receives a query to search for descendants of a given container node X. For example, the search may be for all directories having a root node X.

At block 510, using ancestry table 300, all row entries having container node X as ANCESTOR_ID 140 (an ancestor) are identified as matching the received search query. In this example embodiment, row entries 320, 330, 360 and 395 are identified as matching entries.

At block 515, each matching row entry 320, 330, 360 and 395 is examined to determine whether its DEPTH 145 is greater than 0. If DEPTH 145 is greater than 0, then NODE_ID 135 corresponding to each such entry is identified. Continuing with this example embodiment, only row entries 330, 360 and 395 with corresponding NODE_ID 135 values of W, Y and Z, respectively, are identified. NODE ID 135 values from row entries 330, 360 and 395 are returned, identified and/or temporarily stored at block 520.

Sample code for identifying and returning such entries is as follows:

SELECT ancestry.node_id FROM ancestry
JOIN node ON ancestry.ancestor_id = node.node_id
WHERE ancestry.ancestor_id = ‘X’ AND ancestry.depth > 0;

The SELECT clause returns nodes from NODE_ID 405. The JOIN clause joins together hierarchical table 300 and node table 400 on a matching table column to form a temporary table from which results of the query may be determined.

FIG. 6 shows an example temporary table formed using an example query that uses the JOIN clause. For example, JOIN node ON ancestry. ancestor_id=node.node_id returns a temporary table wherein the entries from ANCESTOR_ID 140 in ancestry table 300 match entries in NODE_ID 405 in node table 400. The WHERE clause further narrows down the results of the query by specifying that the entries in the temporary table created using the JOIN clause adhere to the condition that ANCESTOR_ID 140 of ancestry table 300 is equal to X and the value of DEPTH 145 is greater than 0. The example query returns descendant container nodes of node X (i.e., W, Y and Z), as shown in temporary table 600. In some aspects, the example query may also return descendant leaf nodes. In some alternative example embodiments, matching data may be temporarily stored in an array or other format.

Referring back to FIG. 5, at block 525, the matched nodes may then be used to determine the corresponding directory descendants. Such determination is based upon identifying PARENT NODEs 415 corresponding to the matched nodes. As shown in FIG. 5, NODE_ID 135 values W, Y, and Z correspond to directories having NODE_NAMEs 420 of “USER 1”, “USERS” and “DOC”.

In some example embodiments, where the search query is to identify files within a directory path of C as the root directory C, the matched nodes may be used to identify the corresponding file descendants by identifying PARENT_NODEs 415 corresponding to the matched node and examining NODE_TYPE 410 to determine if the matched nodes are “LEAF” nodes (block 530). In addition, where a NODE_ID 405 entry corresponds to the original search query but not PARENT NODE entry, such node is a leaf node. In this example embodiment, method 500 would produce the results of identifying leaf nodes having files named DOC1, DOC2, DOC 3, DOC 4 and DOC 5.

In yet other example embodiments, where the search query is to identify all files and directories C as the root directory C, example method 500 would result in not only identifying leaf nodes having files named “DOC1”, “DOC2”, “DOC 3”, “DOC 4” and “DOC 5” but also subdirectories named “USER 1”, “USERS” and “DOC”.

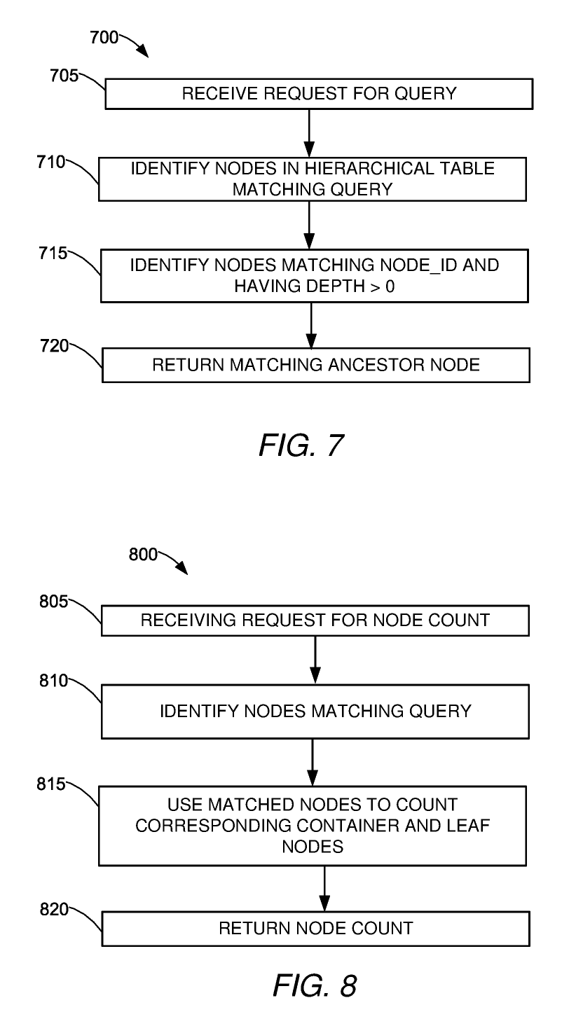

FIG. 7 shows one shows one example method 500 for searching a relational database using the example hierarchical table of FIG. 3D.

At block 705, an example application receives a query to search for ancestors of a given container node Y. For example, the search may be for all directories of a given directory Y.

At block 710, using ancestry table 300, all row entries having container node Y as NODE_ID 140 are identified as matching the received search query. In this example embodiment, row entries 340, 345 and 360 are identified as matching entries.

At block 715, each matching row entry 340, 345 and 360 is examined to determine whether its DEPTH 145 is greater than 0. If DEPTH 145 is greater than 0, then ANCESTOR_ID 140 corresponding to each such entry is identified. Continuing with this example embodiment, only row entries 345 and 360 with corresponding ANCESTOR_ID 140 values of W and X, respectively, are identified. ANCESTOR_ID 135 values from row entries 345 and 360 may then be returned, identified and/or temporarily stored at block 720.

In some example aspects, ANCESTOR ID 135 values identified at block 720 may then be used to correlate the search query results with file or document names. Using this example embodiment, the corresponding NODE_NAME 420 values of the matched entries are “USER 1” and “C”, which then transmitted by the application as the results of the search query.

Corresponding sample code for application performing the example method in FIG. 7 is shown below.

SELECT ancestor_id FROM ancestry
WHERE node_id = ‘Y’ and depth > 0

In this example application, the query returns all container nodes whose descendant is the given container node Z, excluding itself.

The SELECT clause selects all values of ANCESTOR_ID 110 that satisfy the condition set in the WHERE clause. The WHERE clause specifies that the entries of NODE_ID 105 is equal to ‘Z’ and the depth is greater than 0, which indicates that the nodes to be returned from ANCESTOR_ID 110 has a descendant node Z. Specifying that results have depth values greater than 0 excludes the given container node Z. This query returns all the ancestors of node Z (i.e., Y and X) excluding itself.

In another example application, a query to retrieve the distance of a given container node Z from the root is given below:

SELECT MAX(ancestry.depth)
FROM ancestry
WHERE ancestry.node_id = ‘Z’

The maximum value from the DEPTH 115 of ancestry table 100a′ is returned using the query. The value is specified to be the maximum depth value of container node Z using the WHERE ancestry.node_id=‘z’ clause. The value returned using this example query is 2, which is the depth value between container node Z and root node X.

Another example application performs a query to retrieve the distance of a given leaf node A from the root.

SELECT MAX(ancestry.depth) + 1
FROM ancestry
JOIN node ON ancestry.node_id = node.parent_node AND

node.node_type = ‘leaf’

WHERE node.node_id = ‘A’

The maximum value of DEPTH 115 in ancestry table 100a′ retrieved and a value of “1” may be added to the result to account for the leaf node which is not represented in ancestry table 100a′. The JOIN clause creates a temporary table based on node table 300 wherein the values of NODE_ID 105 is equal to the values of PARENT NODE 415 and wherein the value from NODE_TYPE 120 is equal to ‘leaf’ and yet another condition wherein the value from NODE_ID 405 is equal to ‘A’. This query then returns the distance of leaf node A to the root node which is 3.

FIG. 8 shows a third example method for searching a relational database using the hierarchical table of FIG. 3D. In this example embodiment, an example application performs a query to count all descendants of a given container node X.

At block 805, the application receives a request to count all of the descendants of a container node X. At block 810, the nodes matching the query are identified using ancestry table 300. At block 815, the matching nodes are used to count the corresponding container and leaf nodes, and the number of descendants for X is returned at block 820. Corresponding sample code for performing this query is shown below:

SELECT COUNT(*)
FROM ancestry
JOIN node ON ancestry.node_id = node.parent_node OR

node.node_type = ‘leaf’

WHERE ancestry.ancestor_id = ‘X’ AND depth > 0;

The SELECT COUNT returns the number of entries from ancestry table 100a′ wherein NODE_ID 405 entries are equal to PARENT NODE 415 entries or NODE_TYPE 410 records include ‘leaf’ entries, which indicate that all descendants of node X, including container and leaf nodes but excluding itself, are counted. The condition specified in the WHERE clause indicates that the given node whose number of descendants is queried is X, and depth is specified to be greater than 0 to only count descendant nodes. This query then returns the number of descendants of given node X which is 3.

In the example query applications discussed above, selecting one or more entries from the table are performed using single access queries without performing tree traversals and recursions.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 1 need to be performed in accordance with the embodiments of the disclosure and/or additional actions may be performed in accordance with other embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of searching documents in a relational database, comprising:
receiving a search query from an application,
identifying, via an ancestry table, node identifiers corresponding to the search query;
determining, from the corresponding node identifiers, ancestor node identifiers having a depth value greater than zero; and
displaying identifiers associated with the ancestor node identifiers to a user, wherein each entry in the ancestry table includes a node identifier; an ancestor node identifier associated with the node identifier; and a depth value corresponding to a distance between the node identifier and the ancestor identifier; and wherein at least one of the receiving, identifying, determining and displaying are performed by a processor.

2. The method of claim 1, wherein ancestry table corresponds to a file system structure.

3. The method of claim 1, wherein each of the node identifiers corresponds to one of a folder and document identifier in a file system.

4. The method of claim 1, wherein the ancestry table is stored in a non-transitory computer readable storage medium.

5. A non-transitory computer-readable storage medium containing computer executable instructions to:
receive a search query from an application,
identify, via an ancestry table, node identifiers corresponding to the search query;
determine, from the corresponding node identifiers, ancestor node identifiers having a depth value greater than zero; and
display identifiers associated with the ancestor node identifiers to a user.

6. The non-transitory computer-readable storage medium of claim 1, further comprising an ancestry table wherein each entry in the ancestry table includes a node identifier; an ancestor node identifier associated with the node identifier; and a depth value corresponding to a distance between the node identifier and the ancestor identifier.

7. A method of searching a tree structure having one or more nodes comprising:
receiving a search query from an application running on a computing device;
identifying, via an ancestry table, nodes matching the search query;
identifying, from the matching nodes, nodes having a depth value greater than zero;
using the identified nodes, identify corresponding ancestor nodes; and
outputting to the application an identity of the corresponding ancestor nodes.
